(19) United States
(12) Patent Application Publication
(10) Pub. No.: US 2006/0208385 A1
(43) Pub. Date: Sep. 21, 2006

(54) Process for manufacturing a solid door from a fiber plate (board) using a molding press

(76) Inventor: Ahmet Ceritoglu, Istanbul (TR)

Correspondence Address: KEITH FRANTZ, 401 WEST STATE STREET, SUITE 200, ROCKFORD, IL, 61101, US

(21) Appl. No.: 11/083,116

(22) Filed: Mar. 17, 2005

(51) Int. Cl. B27N 3/00

(52) U.S. Cl. 264/109; 264/319

(57) ABSTRACT

This invention is related to the manufacturing process of a “DOOR” suitable to be used to obtain separate sections for places built in building and construction sector and known as a separation tool. The process comprises initially adding chemical adhesive, bonding substance and optionally chemical agents providing strength against high temperature, moisture and fire to the fibers produced from wood and other cellulosic materials and drying up to a certain degree of humidity, then pressing these fibers under vapor, temperature and pressure, subsequently obtaining a mainly homogenous (higher densities on the both surfaces due to the heat and pressure while pressing with molds which results in better paint applications as well as surface covering materials; such as pvc, folio, veneer, laminates, etc.) solid product from a desired-density fiber plate with a density between 300 kg/cubic meter to 800 kg/cubic meter or subsequently (optionally) obtaining materials with different thickness of walls by pressing the product with high temperature and pressure again in a “Molding Press (using either both concave upper and lower molds or both convex upper and lower molds) and forming unlimited designs of geometrical figures on it.

### CROSS-REFERENCES TO RELATED APPLICATIONS

None

Reference to sequence listing, table, or computer program listing appendix submitted on a compact disc: N/A.

Statement regarding federally sponsored research or development: N/A.

### BACKGROUND OF THE INVENTION

1. Field of Invention

This invention is related to the manufacturing process of a “DOOR” suitable to be used to obtain separate sections for places built in building and construction sector and known as a separation tool. The process comprises initially adding chemical adhesive, bonding substance and (optionally) chemical agents providing strength against high temperature, moisture and fire to the fibers produced from wood and other cellulosic materials and drying up to a certain degree of humidity, then pressing these fibers under steam, temperature and pressure, subsequently obtaining a homogenous (higher densities on both surfaces due to the heat and pressure while pressing with molds which results in better paint applications as well as surface covering materials; such as pvc, folio, veneer, laminates, etc.) solid product from a desired-density fiber plate with a density between 300 kg/cubic meter to 800 kg/cubic meter or subsequently (optionally) obtaining materials with different thickness of walls by pressing the product with high temperature and pressure again in a “Molding Press” (using either both concave upper and lower molds or both convex upper and lower molds) and forming unlimited designs of geometrical figures on it.

2. Background Art

Doors have been manufactured by performing various engraving processes on natural wood for many years. These engraved doors are produced on custom-made basis. However, since such a process is limited in terms of production capacity, very costly to produce and naturally a very difficult manufacturing process; there is a substantial demand for mass-production of these engraved high quality doors.

Switch to the mass door production was initiated by transforming raw wood to lumber, sizing and kiln drying (decreasing its moisture content), then forming a rectangular door spar from natural wood and organizing lumber girders horizontally with certain distance in-between them and pressing a thin-wall, figured or non-figured plywood on both surfaces.

Later on, a grooved plate (grooved splinter plate) was used instead of wooden door girders in order to decrease the total cost of manufacturing doors, and as a result certain amount was saved. Afterwards, this material was substituted with honeycomb sheet, which is still used today.

Surface coating process in the serial door production was initiated with plywood (obtaining a roll by stripping a plank timber and then drying, sizing, gluing these wooden sheets in rolls, making their butt ends overlapped each other (vertically and horizontally) and pressing them).

Later on, need for a low cost, thin walled door surface-coating panels induced the inventions such as splinter plate, MDF, formed MDF (Door Skin). These developments resulted in both more cost-effective production and a visual variety in the shapes of doors to a certain degree.

Separators known as doors and used to separate the places in the construction sector are manufactured by processing a massive wooden material in the carpenter workshops or in the plants. In these workshops and plants, a “Door Spar” (outer frame) is assembled using rectangular assembly methods (widely-used in door sector) with nailing or gluing of a natural material.

Into the middle part between bottom-top and side edges of the rectangular product obtained at the end of this assembling process, any filling material such as strophore, honeycomb sheet, various low density board sheets, is filled, and surface plates composed of various raw, dyed or coated materials, which are thin walled (3-5 mm) and preformed are mounted (pressed) to the front and back sides of the frame.

Although these surface plates are thin walled, their formed parts have extrusions to the inner spaces, these extrusions being between 6 and 13 mm for each surface plate depending on the depth of the geometrical shape. When looking at the doors from the lateral section, the formed parts of the surface plate seem to be situated inner from the parts assembled to the door frame (that is, from the line of door spar) and having a line so that the filling material in the middle part are pressed.

In this and similar manufacturing methods, a process used for manufacturing a door is complicated and it takes long time. First of all, the timber which forms the door frame is subjected to a drying and kiln drying process in order to protect from bending or warping over time. This process is not cost effective since it takes long time.

Strength of a door manufactured in such manner is substantially low. Because the filling material used is spongy and weak, plus since the surface coating materials mounted onto both surfaces of the frame are not thick, this door's impact resistance is lower than a door manufactured from a solid fiber plate.

A “Door” which can show all aspects of a natural wood since it is manufactured with “A Process for Manufacturing a Solid Door from a Fiber Plate using a Molding Press”, being the subject of this invention and manufactured from a desired density fiber plate has an advantage of bearing all functional and resistance aspects of a natural wooden door and additionally can be strengthened against fire and moisture with the chemicals optionally injected between the fibers during manufacturing process. Furthermore, as the process of the invention allows for a serial production, the daily production capacity is much higher compared to the daily production capacity of the conventional wooden doors. The thickness of a door which is accepted around the world is mainly between 35 and 60 mm. By using the method of injecting steam into the raw wooden paste a solid door which is homogenous and well-balanced can be obtained with all the advantages of thickness and weight

### SUMMARY OF THE INVENTION

“A Process for Manufacturing a Solid Door from a Fiber Plate (Board) using a Molding Press” which is the subject of this invention comprises six main phases.

FIRST PHASE: In this stage a filamentous structure in the form of cotton is obtained from small particles, namely chips of wood and other cellulosic materials, with impact and centrifugation created by two discs with a high capacity, one disk being fixed and other disk rotating. Also in this stage chemical additives are injected and pre-drying process takes place. Afterwards this cotton like fiber material is formed and spread on the belt conveyor.

SECOND PHASE: In this stage, the cotton like fiber material passes through rotating rollers in order to remove residual air pockets. The fiber material also goes through a scanner to eliminate unwanted objects.

THIRD PHASE: The obtained filamentous structured fiber material containing chemical additives (in this stage water, chemical adhesives and other chemical agents are injected to the fiber again in addition to the chemical injection which takes place in phase 1) is pressed under steam, air, pressure and temperature to obtain a low density fiber plate. immediately after this process, the plate enters the main press.

FOURTH PHASE: The main press has various pressure zones which enables to determine the density profile of the solid fiber door. During pressing various pressures and temperature is applied in order to produce the desired density solid fiber door. Since, just before the main pressing steam has been injected to the core, the pressing time decreases substantially increasing the production capacity. At the end of this phase, the solid fiber flat surface door is obtained. Afterward trimming, cooling and sizing takes place to form the desired dimensions of the door.

FIFTH PHASE: The solid flat surface fiber door enters the molding press. The press has either both concave upper and lower molds or both convex upper and lower molds in order to obtain unlimited designs on both faces of the door. High temperature and pressure is applied here to obtain the final desired density and thickness. During this pressing process optionally various surface materials (placed under and over the door surface) such as pvc, chemically treated thin sheets, etc. can be feeded to the press with the door to achieve a final shaped as well as coated door which doesn't need further surface finishing application.

SIXTH PHASE: In this final stage, the door which is either flat surfaced (obtained at stage four) or designed with the molding pressing (obtained at the stage five) is machined for lock and hinge locations. Also optionally other finishing materials like paint, pvc, veneer, laminates etc. are applicable at this stage.

### BRIEF DESCRIPTION OF THE DRAWINGS

FIG. 1 is a diagram showing the phases of a system of “A Process for Manufacturing a Solid Door from a Fiber Plate using a Molding Press” in accordance with the invention, from the beginning to the end.

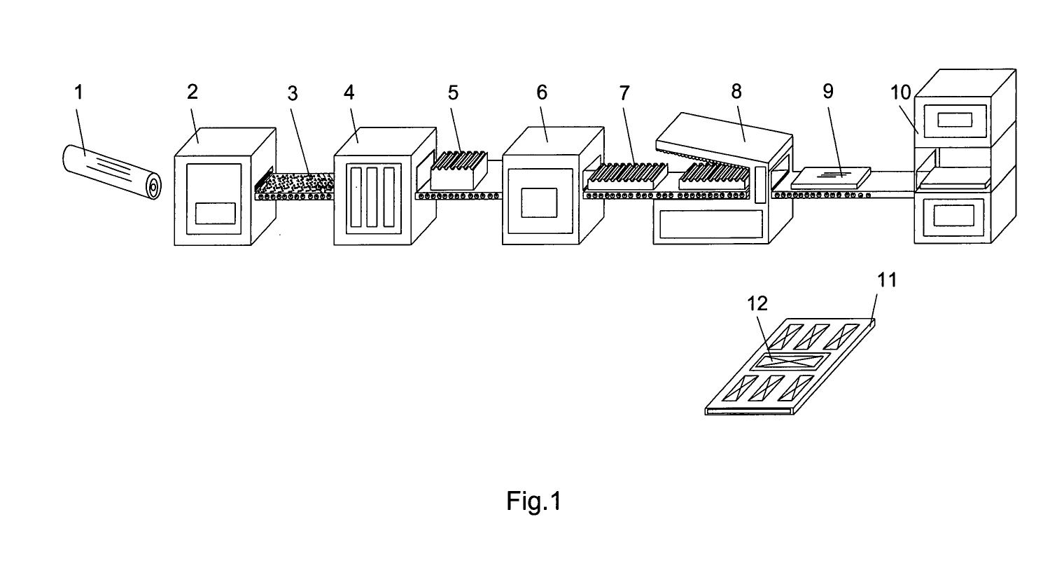

“A Process for Manufacturing a Solid Door from a Fiber Plate using a Molding Press”, which is the subject of this invention is numbered as shown in FIG. 1, the phases corresponding to the numbers being detailed.

No Name of Phase or Item Shown in FIG. 1
1 Wood and/or other cellulosic materials
2 Phase for obtaining a fiber material from wood and/or other cellulosic materials, adding chemical additives and pre-drying and forming
3 homogenously spread fibers
4 Phase for spreading out the fiber material and removing the air pockets
5 Fiber material spread out and from which air pockets have been removed
6 Phase for injecting steam, air, water and chemical additives to the fiber material
7 Pre-formed homogenous fiber material containing chemical additives
8 Phase for obtaining a desired density fiber plate from a fiber material by pressure and heat application
9 A solid fiber plate door
10 Phase for shaping a desired shape solid door plate using a molding press (using either both concave upper and lower molds or both convex upper and lower molds)
11 Phase of the final process (engraving grooves, cavities, dying, coating etc.)
12 The Final figured door

### DETAILED DESCRIPTION OF THE INVENTION

“A Process for Manufacturing a Solid Door from a Fiber Plate using a Molding Press”, being the subject of this invention, is shown in FIG. 1, and includes six main phases. The process allows for serial or continuous production of doors with the use of moving conveyors and air tubes that carries the material from one phase to the next phase.

The first phase of the process, indicated at 2 in FIG. 1, includes obtaining a filamentous structure 3 from small particles, namely chips 1 of wood and other cellulosic materials, with impact and centrifugation on the chips created by two discs with a high capacity, one disk being fixed and the other disk rotating, in a machine of the type known in the industry, to obtain a fluffy fiber structure 3 in the form of cotton. At this first phase, the process also includes adding a chemical adhesive, bonding substance to the fibers 3 to bond the fibers together, and adding other chemical agents (optional) to the fibers 3 to strengthen the fibers and the finished product against (i.e., enhance or increase resistance to detrimental effects) high temperature, moisture and fire; drying the chemically treated fiber, such as with heat radiating resistances, up to a predetermined degree of humidity (i.e., dampness or moisture content), but at this phase, the fiber still retains a degree of moisture content from the chemicals (adhesives and agents); or in other words pre-drying to a certain degree of humidity.

The second phase of the process, indicated at 4 in FIG. 1 consists of spreading out the fiber; and pressing the fiber by passing the fiber through rotating rollers of a pre-press (e.g., at 4), to remove residual air pockets resulting in a semi-compact, semi-dried, and spread out fiber 5 with chemical additives and without air pockets. In processing the fiber structure 3 into the fiber structure 5, the fiber structure 3 can be pre-pressed as indicated at 4, to obtain the pressed filamentous structure 5 with chemical additives.

In the third phase, indicated at 6 in FIG. 1, the obtained filamentous structured fiber material containing chemical additives 5 is pressed under steam which can be mixed with water and air, also some pressure is applied to obtain a low density fiber plate. At this stage chemical adhesives, other chemical agents are injected to the fiber again in addition to the chemical injection which takes place in Phase 1. At this process 6, a low density fiber material is formed 7 ready to enter the main pressing at the next stage.

In the fourth phase of the process, indicated at 8 in FIG. 1, the obtained filamentous structure 7 is pressed under heavy pressure (e.g. rollers in a serial process), high temperature (e.g., approximately or greater than 2000° C.) and to produce a desired density fiber plate 9 with a density of between 300 kg/cubic meter to 800 kg/cubic meter. Immersing the filamentous structure in the high temperature as it passes through and is pressed in the phase indicated at 8, results in the high temperature and pressure influences at the phase at 8 reaching the inside of relatively thick structures, and enables production of a fiber plate with the desired strength and density characteristics (between 300 kg/cubic meter to 800 kg/cubic meter) and a finished thickness of up to 60 mm if desired. The steam which is injected at the previous phase 6, increases the effectiveness of the pressure and temperature as applied on the outside of the filamentous structure to reach the inner parts and thereby in obtaining the desired density fiber plate; and the moisture content retained in the fiber in the second phase is established to prevent or preclude the burning, scorching, etc. of the fiber when exposed to the high temperature pressing action. In general, the fiber plate 9 has the form of a flat surfaced door manufactured from the fiber plate. If desired to shape the product after this phase, the flat door is taken to a subsequent shaping phase in a molding press.

In the fifth phase of the process, indicated at 10 in FIG. 1, a solid door is manufactured from the desired density fiber plate 9. The fiber door is carried or conveyed to the molding press (10) and again pressed (using either both concave upper and lower molds or both convex upper and lower molds) under pressure and high temperature, thereby, the density of the plate/door is further increased by thinning its wall. The door can be optionally sprayed with additional chemical additives in order to avoid sticking to the molds and/or to have a better surface quality. Desired surface geometrical forms can also be established (e.g., pressed, drawn or engraved) in the molding press., or with other molding or forming apparatus mounted to or following the molding press in the serial process, and thereby a door on which both surfaces are provided with geometrical figures is produced. Also different surface covering materials (pvc, chemically treated thin sheets, etc) during this pressing can be placed under and over the door surface and fed to the press with the door. And as a result of this optional application a final shaped and coated door can be obtained which doesn't need further surface finishing process.

In the sixth phase of the process, indicated at 11 in FIG. 1, a solid door manufactured from the desired density fiber plate 9 is finished with the processing of hinge and lock places appropriate for the desired installation. A finished door 12 is introduced to the market after it is optionally or additionally painted or coated (pvc, veneer, laminates etc.) followed by a packaging process.

1. A Process for Manufacturing a Solid Door from a Fiber Plate (Board) using a Molding Press, the process comprising (a) initially adding chemical adhesive, bonding substance and, optionally, adding chemical agents providing strength against high temperature, moisture and fire to fibers produced from wood and other cellulosic materials and drying the fibers with chemical additives up to a certain degree of humidity, (b) then pressing these fibers under steam, temperature and pressure, (c) subsequently obtaining a substantially homogenous solid product—with higher densities on both surfaces due to the heat and pressure while pressing with molds which results in better paint applications as well as surface covering materials including pvc, folio, veneer and laminates—from a desired-density fiber plate with a density between 300 kg/cubic meter to 800 kg/cubic meter, (d) subsequently, optionally, obtaining materials with different thickness of walls by pressing the product with high temperature and pressure again in a Molding Press using either both concave upper and lower molds or both convex upper and lower molds and forming designs of geometrical figures on it.

2. A Process for Manufacturing a Solid Door from a Fiber Plate (Board) using a Molding Press according to claim 1 further comprising providing the fibers as filamentous structure in the form of cotton obtained from small particles, namely chips of wood and other cellulosic materials with impact and centrifugation created by two discs with a high capacity, one disk being fixed and the other disk rotating, injecting the chemical adhesive, bonding substance and optional chemical agents into the filamentous structure, pre-drying the filamentous structure with chemical additives to said degree of humidity, and spreading the fiber with onto a conveyor belt.

3. A Process for Manufacturing a Solid Door from a Fiber Plate (Board) using a Molding Press according to claim 2 further comprising pressing the spread-out fiber material by passing the material through rotating rollers of a pre-press to remove residual air pockets and obtain a pressed filamentous structured fiber material containing chemical additive.

4. A Process for Manufacturing a Solid Door from a Fiber Plate (Board) using a Molding Press according to claim 3 further comprising pressing the filamentous structured fiber material containing chemical additives under steam, pressure and temperature to obtain a low density fiber plate, and optionally injecting additional chemical adhesives and chemical agents into the filamentous structured fiber material.

5. A Process for Manufacturing a Solid Door from a Fiber Plate (Board) using a Molding Press according to claim 4 further comprising pressing under high pressure and high temperature, in a main press, the low density fiber plate previously injected with steam to obtain the desired density fiber plate with a density between 300 kg/cubic meter to 800 kg/cubic meter in the form of a solid fiber flat surface door.

6. A Process for Manufacturing a Solid Door from a Fiber Plate (Board) using a Molding Press according to claim 5 further comprising forming lock and hinge locations in the solid fiber flat surface door and optionally coating or covering the sides of the door with a finishing surface treatment or surface covering material.

7. A Process for Manufacturing a Solid Door from a Fiber Plate (Board) using a Molding Press according to claim 5 further comprising pressing the solid fiber flat surface door in the Molding Press under high temperature and pressure with the concave or convex molds to obtain a final configured door with desired finish density and thickness and optionally formed geometrical figures on both sides of the door, and optionally coating or covering the sides of the final configured door with a finishing surface treatment or surface covering material.

8. A Process for Manufacturing a Solid Door from a Fiber Plate (Board) using a Molding Press according to claim 7 further comprising forming lock and hinge locations in the final configured door.

9. A method for manufacturing a solid door comprising:
(a) adding chemical adhesives, bonding substance to filamentous fibers of wood and other cellulosic materials to obtain fibers with chemical additives and pre-drying the fibers to a certain degree of humidity;
(b) spreading out and pressing the pre-dried fibers in a pre-press to remove residual air pockets and obtain a pressed filamentous structure;
(c) pressing the filamentous structure under steam to obtain a low density fiber plate;
(d) pressing the low density fiber plate with previously injected steam under high pressure and high temperature to obtain a desired density fiber plate with a density of between 300 kg/cubic meter to 800 kg/cubic meter;
(e) producing a finished door from the desired density fiber plate.

10. The method of manufacturing a solid door according to claim 9 further comprising adding chemical agents providing strength against high temperature, moisture and fire to the fibers prior to pre-drying the fibers.

11. The method of manufacturing a solid door according to claim 9 in which pressing the pre-dried fibers includes passing the fibers through opposing rotating rollers in a pre-press to remove the residual air pockets and obtain the pressed filamentous structure.

12. The method of manufacturing a solid door according to claim 9 further comprising injecting additional chemical additives and/or bonding substance during the phase of pressing the filamentous structure under steam.

13. The method of manufacturing a solid door according to claim 9 in which pressing the low density fiber plate with previously injected steam includes pressing under high temperature greater than approximately 200 degrees C.

14. The method of manufacturing a solid door according to claim 9 in which producing the finished door includes forming a solid flat fiber door with hinge locations and optional surface treatments or coatings from the desired density fiber plate.

15. The method of manufacturing a solid door according to claim 9 in which producing the finished door includes forming a solid flat fiber door, pressing the flat door in a Molding Press under high temperature and pressure with opposing concave or convex molds to obtain a final configured door with desired finish density and thickness and optionally formed geometrical figures on the sides of the door, and optionally coating or covering the sides of the final configured door with a finishing surface treatment or surface covering material.

16. The method of manufacturing a solid door according to claim 9 further comprising providing the filamentous fibers in the form of cotton obtained from small particles, namely chips of wood and other cellulosic materials, with impact and centrifugation created by two discs with a high capacity, one disk being fixed and the other disk rotating.

17. A method for manufacturing a solid door method comprising:
(a) providing filamentous fibers in the form of cotton obtained from small particles, namely chips of wood and other cellulosic materials with impact and centrifugation created by two discs with a high capacity, one disk being fixed and the other disk rotating;
(b) adding chemical adhesive, bonding substance and, optionally, adding chemical agents providing strength against high temperature, moisture and fire to the filamentous fibers;
(c) pre-drying the filamentous fibers with chemical additives to a certain degree of humidity;
(d) spreading the pre-dried filamentous fiber with onto a conveyor belt;
(e) pressing the pre-dried spread-out fibers in a pre-press between rotating rollers to remove residual air pockets and obtain a pressed filamentous structure;
(f) pressing the filamentous structure under steam to obtain a low density fiber plate, and optionally injecting additional chemical adhesive, bonding substance and chemical agents to the filamentous structure;
(g) pressing the low density fiber plate with previously injected steam under high pressure and high temperature to obtain a desired density fiber plate with a density of between 300 kg/cubic meter to 800 kg/cubic meter;
(h) obtaining a flat surface door from the desired density fiber plate; and
(i) one of:
i) finishing the flat surface door, or
ii) pressing the flat surface door in a Molding Press under high temperature and pressure with either opposing concave upper and lower molds or opposing convex upper and lower molds to obtain a geometrically configured door, and finishing the geometrically configured door with surface coatings or surface treatments and hinge locations.
